(19) United States
(12) Patent Application Publication
(10) Pub. No.: US 2002/0142763 A1
(43) Pub. Date: Oct. 3, 2002

(54) Initiating a push session by dialing the push target

(76) Inventor: Amir David Kolsky, Binyamina (IL)

Correspondence Address: KENYON & KENYON, ONE BROADWAY, NEW YORK, NY, 10004, US

(21) Appl. No.: 09/819,489

(22) Filed: Mar. 28, 2001

(51) Int. Cl. H04M 3/00

(52) U.S. Cl. 455/419; 455/445

(57) ABSTRACT

The present invention relates to a method and apparatus for initiating the delivery of a push message to a push destination associated with a communication device connected to a telephony network.

### FIELD OF THE INVENTION

The present invention relates to a method and apparatus for initiating the delivery of a push message to a push destination associated with a device connected to a telephony network.

### BACKGROUND INFORMATION

There are two distinct modes a user may employ when interacting with a data service—a push mode and a pull mode. A user pulls information by establishing a connection with the information provider and sending a request for data. For example, if the information provider is associated with an HTTP (HyperText Transfer Protocol) server, than a pull is done by submitting an HTTP GET or POST requests to the information provider, and waiting for the reply from the provider or its agent which contains the result of the request. The important thing to note in the pull mode is that the user is the initiator of the request, such as, requesting data from a provider. However, in a push mode a user may request information to be sent or pushed to him when a specific event occurs, for example, a flight is delayed or a result for a sporting event is available or a stock has reached a predetermined price. In these events the provider pushes the information back to the requester when the specific event occurs.

Push requests may be non-interactive (offline) requests, or they may be interactive (online) requests. Offline requests can be used when information is sent to the user and no further interaction is required, e.g., the score of a sporting event. Online requests are used when the information sent to the user is part of a longer interaction, e.g., a seat on a particular flight opened up and the user needs to provide credit card information so to complete the ticket purchasing transaction.

An offline push request may be sent over a non-interactive medium. For example, the information provider may send information to the user by email, or if the user is on a phone with SMS (Short Messaging System) capabilities, the information may be packaged in an SMS message and sent to the user.

If the information provider initiating the push request (the push initiator) needs to interact with the user then a more complex scheme must be used. If the user's device has a dedicated mechanism to wait and listen for incoming push requests than the push initiator may use this mechanism. For example, the device may have an HTTP server with a specific process dedicated to listening for incoming push requests on a designated push port. This greatly simplifies the pushing process. However, this is where we run into a common problem: it is much easier to pull information than to push information. The resources on client devices are much constrained compared to server devices and clients are therefore more amenable to pull operations which require less resources than to push operations. The resulting mode of operation is commonly known as turning a push into a pull. For example, if the user has an email account and Internet access, an email message with a URL (Universal Resource Locator) for a web form can be embedded in the email message. The user will read the email and if he desires to continue the push interaction, he will click on the link. In this case, the push process had two stages. The first is the push initiator signals the user to establish a session with it. And, in the second stage the user pulls the information from the push initiator.

If the user is associated with a telephony device then in most cases the device is incapable of accepting an online push request. The devices currently available are very limited in the number of events they can process. This is unavoidable because of the nature of the network the device is connected to. For example, a phone connected to a PSTN (Public Service Telephone Network) can only wait for one event: call establishment. The present 2G mobile phones are capable of accepting two types of events: a call establishment event and a receipt of a system message. However, they do not have the capability to deal with incoming online push messages.

When a call event is received, the phone software usually checks the identity of the calling party against a set of listed phone numbers, such as, the local phone book, and displays a message to the user with the identity of the calling user if it is found, or informs that the calling party's phone number is not found in the phone book.

When a system message is received, the phone's software determines the operation to be performed based on the message type and content. For example:

(a) The message may contain an operator logo which is displayed when the phone is inactive. In this case the user may elect to view, erase, forward or accept the logo. The phone interacts with the user to determine which action is to be taken.

(b) The message may contain provisioning information that is sent by a WAP (Wireless Application Protocol) service provider. The user may erase or accept the provisioning information as presented to him by the phone.

(c) The message may contain a new voice mail indication, in which case the phone will display an indication for the user that she has a new voice message waiting for her. An appropriate message could then be sent to the phone to turn the indication off once the user has heard all her new messages.

(d) The message may contain user text. In which case the user may read, erase, forward or perform other actions on the message. Again, it is the phone's responsibility to display the message and the alternative actions to the user. This, in fact, is the default action in most cases and if a phone receives an unrecognized message it will usually appear as garbled text to the user.

All phones with data capabilities, for example, WAP, iMode and HDML (Handheld Device Mark-up Language) phones can initiate a pull session with an information provider. The bearer used for the data session may be a voice circuit using the phone's built in modem, it may be a packet data bearer such as CDPD (Cellular Digital Packet Data) or GPRS (General Packet Radio Service) or it might even be a two way SMS bearer. The trigger for the session establishment is usually a request from the user, by clicking a button or selecting a menu option.

An alternative trigger for a data session initiation maybe the receipt of a special message, which is interpreted by the phone as a Session Initiation request. A special software—a Session Initiation Application (SIA)—is invoked to initiate a session with the push initiator. Once the data session is established, the pushed message is pulled into the phone and its processing commences. This is another example of the push turned to pull mechanism.

System messages, by their nature, are generated by the system, usually as a result of a request by an external entity. For example, a Text Message is generated when another user or some service provider requests the system through a Short or Small Message Server Center (SMSC) to send one to the user. A Session Initiation Message (SIM) is generated when a push initiator requests the SMSC to send a message. In all cases the messages are generated by the SMSC. This means that there must be an intimate relationship between the push initiator and the network, which is both hard to maintain and costly as far as the push initiator is concerned.

### PURPOSES AND SUMMARY OF THE INVENTION

The invention is a novel method and an apparatus for establishing a push session between a push initiator and a telephone device.

Therefore, one purpose of this invention is to provide an apparatus and a method that will provide a communication link between a push initiator and a telephone device.

Another purpose of this invention is to provide for an apparatus and a method for programming a telephone device to accept or reject communications from a push initiator.

Still another purpose of this invention is to have an apparatus and a method through which push message constructed by an information provider is communicated to a target.

Yet another purpose of this invention is to provide a telephone device that can differentiate between a communication from a push initiator and other communication that is sent to it.

Still yet another purpose of the invention is to be able to utilize a portion of the existing public telephone network and be able to use to establish communication between a push server and a telephone device.

Therefore, in one aspect the invention is a method for initiating a push session, comprising:

(a) sending a message from a push initiator to a device, wherein said message has at least one embedded ID corresponding to said push initiator;

(b) matching said embedded ID with a list of ID's in said device;

(c) rejecting said message if the embedded ID matches with at least one ID in said device, and triggering said device to initiate a push session with said push initiator.

In another aspect the invention is a method of setting-up a device, comprising:

(a) accessing a memory location on said device; and

(b) storing at least one ID corresponding to at least one push initiator.

In yet another aspect the invention is a method for initiating a push session, comprising, sending a message from a push initiator to a telephony device wherein said message is sent via a telephony network as a call initiation request.

In still another aspect the invention is an apparatus comprising a push initiator connected to a communication device.

### BRIEF DESCRIPTION OF THE DRAWINGS

The features of the invention believed to be novel and the elements characteristic of the invention are set forth with particularity in the appended claims. The drawings are for illustration purposes only and are not drawn to scale. Furthermore, like numbers represent like features in the drawings. The invention itself, however, both as to organization and method of operation, may best be understood by reference to the detailed description which follows taken in conjunction with the accompanying drawings in which:

FIG. 1 illustrates a telephone system of the prior art.

FIG. 2 illustrates a preferred embodiment of this invention.

FIG. 3 illustrates telephone set-up service using a preferred embodiment of this invention.

FIG. 4 is a process for establishing a session with a Push Initiator using a preferred embodiment of this invention.

FIG. 5 illustrates a preferred embodiment of an alternative setup procedure for updating the Push Initiators Database by sending a provisioning message.

FIG. 6 is a flow chart describing the preferred process for this invention.

### DETAILED DESCRIPTION OF THE INVENTION

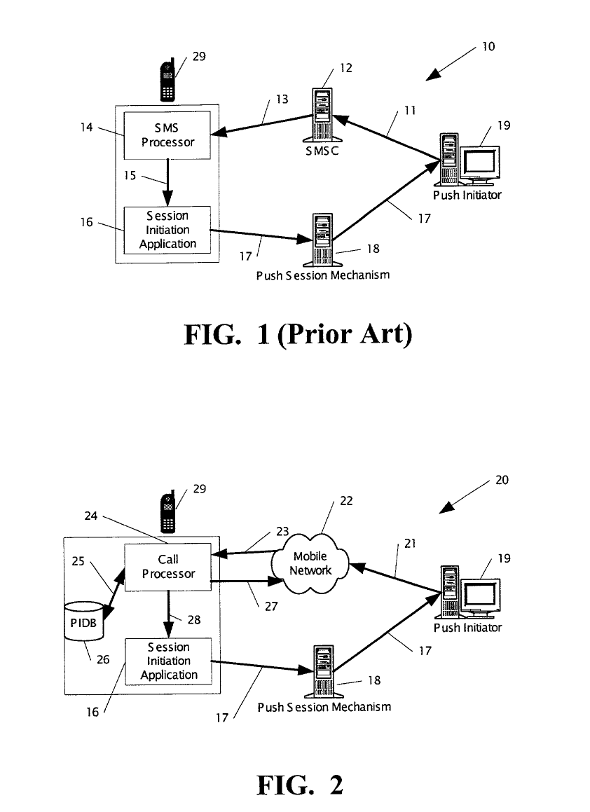

FIG. 1, illustrates a telephone system 10 of the prior art of push initiation. A push initiator 19 sends an SMS PSI (Short Message Service Push Session Inititation) request 11 to an SMSC (Short Message Service Controller) 12 for delivery to mobile phone 29 (for example, using the SMPP protocol). The SMSC 12 sends the SMS 13 to the phone 29 using the appropriate network dependant means. The SMS Processor 14 executing in the phone 29 examines the incoming SMS 13 and if it recognizes it as a Push Session Initiation request 11 forwards it to a specific Session Initiation Application (SIA) 16 via a connection 15 in the phone 29 that will establish a push session 17 using an established session initiation mechanism 18 with the push initiator 19.

FIG. 2, illustrates a preferred embodiment 20 of this invention where the invention utilizes the equipment already being used by the mobile carriers. The push initiator 19 attempts to place a call 21 using a telephony device or a special network gateway via the central exchange or mobile network 22 to a device 29 such as a mobile phone 29. The device 29 is sent a control message 23 by the network advising it of an incoming call 21 with the push initiator's 19 caller ID encoded in the message. A call processor 24 executing in the phone 29 examines the incoming call request 23 and retrieves the calling party ID embedded in the call request 23. Once retrieved, this number is checked at 25 against a database of push initiators' caller IDs or Push Initiator Data Base (PIDB) 26. If the calling ID matches one of the number is the database 26 the call 23 is rejected via connection 27 and the Session Initiation Application 16 is informed via connection 28 that it should establish a push session 17 with the push initiator 19 using the standard push session mechanism 18.

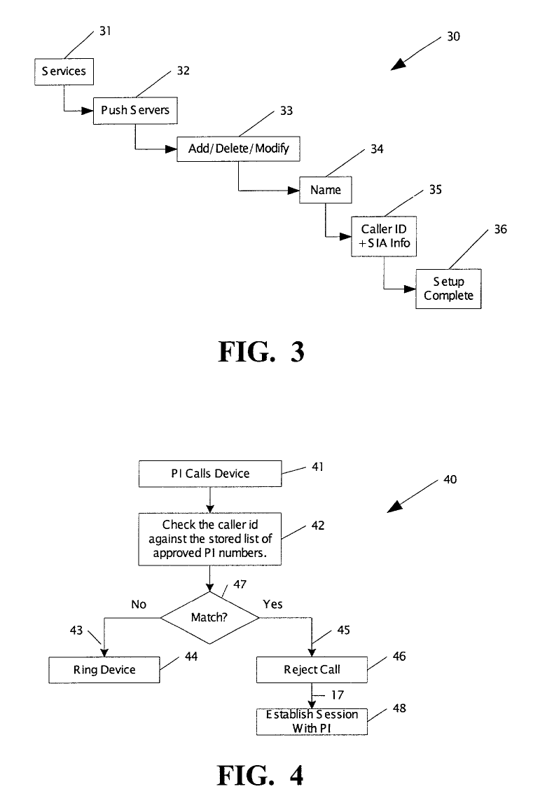

FIG. 3 illustrates a telephone set-up service 30 using a preferred embodiment of this invention. Using services 31 on the phone 29 a menu is accessed. On this menu a section is reserved for one or more push servers 32. Once the menu for the push server 32 is displayed it is then updated by either adding or deleting or modifying the push server information at 33. Typically, the push server name 34 is updated and then the push server caller ID and Session Initiation Application (SIA) information 35 is updated. At step 36 the set-up is completed and the phone 29 has been updated to be able to identify a call from and communicate with a Push Initiator 19.

FIG. 4, is a process for establishing a session 40 with a Push Initiator 19 using a preferred embodiment of this invention. At step 41 a Push Initiator 19 initiates a phone call 21 via the central exchange or mobile network 22 as already discussed with reference with FIG. 2. Once the call reaches the phone 29, the phone 29 at step 42 checks the incoming phone call against a list of Push Initiator numbers which the phone 29 had been programmed as discussed with reference with FIG. 3. If the incoming phone number does not match at 47 against the list of Push Server numbers 26, the phone call is routed at 43 and the phone rings at 44 so that the phone 29 can be answered as a regular incoming phone call. However, if the incoming phone number matches at 47 against the list of Push Server numbers 26, the phone call is then routed at 45 and the phone call is rejected at 46 and a session with the Push Initiator 19 is established at step 48 via the communication link 17.

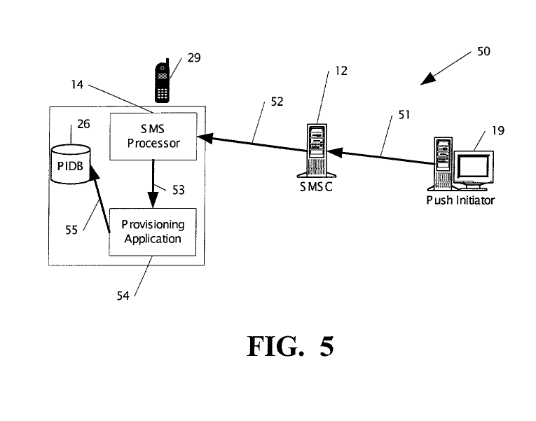

FIG. 5 illustrates the preferred embodiment of an alternative setup procedure 50 for updating the Push Initiators Database 26 in the phone 29 with the information needed to identify a push initiation call 20 from a push initiator 19 and to establish a push session 17 with the push initiator 19 by sending a provisioning message. The push initiator 19 sends an SMS Provisioning message 51 through SMSC 12 to mobile phone 29. The SMS processor 14 receives the SMS message 52 and identifies it as provisioning message. The processor 14 then invokes the provisioning application 54 executing in the phone 29 with the provisioning request 53. The provisioning application 54 informs the user of the provisioning request and seeks approval to provision the phone according to the provisioning request. Once the approval is granted, the information is updated 55 in the push initiators' database 26.

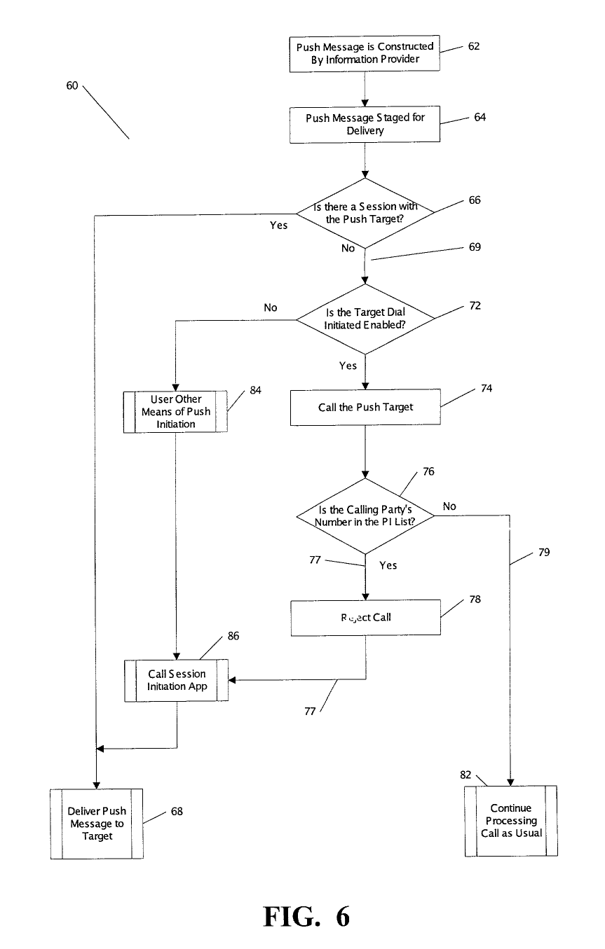

FIG. 6 is a flow chart describing in detail the preferred process 60 for this invention. A push message is constructed by an information provider 62 and the Push message is staged for delivery 64. At step 66 the system could investigate if there is a session with the push target. If there is a session then the push message could be delivered to the target 68 via the communication link 67. However, if it is established at step 66 that there is no session with the push target then the message could be sent via link 69 to see if the target is “call-to-initiate-push session” enabled, at 72. If it is thus enabled, the call could then be routed to the push target 74. Once the push target is called the push target could then look at its resident directory to see if the calling party's number is or is not on the list at 76. If the calling party's number is not on the list then the target could continue processing the call as usual at 82 via the link 79 as a regular incoming telephone call. However, if the calling party's number is on the list then the call could be rejected at 78, and a link 77 could be established with the Push Message initiator and the communication could be routed to a call session initiation application 86 and the Push Message could be delivered to the target at 68. If the target is not “call-to-initiate-push session” enabled, one could use other means of push initiation 84 and communicate with the call session initiation application 86 and then establish a session and deliver a push message to the target at 68.

As stated earlier that the initiation of a push session by using a system message is cumbersome and costly and therefore this invention lends itself very nicely as a set-up to initiated a push session.

With this invention no major alterations have to be made to an existing telephone software or hardware. In order for this invention to work on an existing phone system the existing phones can be altered in two ways. In one case a list (PI (Push Initiator) List) of phone numbers representing acceptable push initiators (similar to the current phone list) could be maintained in the phones along with the means to update the PI list. While, in the second case the call acceptance procedure in the phone could be altered to check and see if an incoming call is from a number which appears on the PI list. If the incoming number is not on the PI List then the processing of the phone call could continues as a normal phone call. However, if the incoming number is on the PI list, then the call could be rejected and the Session Initiation Application (SIA) could be invoked with the appropriate parameters to contact the push initiator.

This invention does not preclude a message based push initiation or any other push initiation schemes to coexist on the phone.

A third alteration to the phone which is possible is the ability to accept remote set-up or provisioning of the push initiator identification an session initiation information via a provisioning message, for example, via SMS. This set-up can be done manually or automatically, and it can be done remotely or on location.

During the set-up if the entry is accepted the entry is inserted in the PIDB and its associated parameters for session set-up. However, if the entry already exists in the PIDB then the information is updated with or without user acknowledgement.

It is also very clear that with this invention the network software and the network configuration could not be affected, and that the existing network software and configuration can easily be accommodated with this invention.

To use this invention effectively the push initiator should be able to generate a phone call with the caller ID which corresponds to the number stored on the phones. The push initiator must also be able to manage the list of targets that are capable of initiating the push session by dialing to them. Similarly, the PI must also be able to provide some reasonable response in case the phone call is inadvertently answered.

An advantage of this invention is that it allows any push initiator to quickly and efficiently access a push target which is addressable through a telephony network, in a manner which is controlled by the user of the telephony device, without requiring any changes to the existing communication network infrastructure.

The system will ring over land lines where the ID is embedded as a caller ID. However, for a digital network, such as, an ISDN or cellular network where the ID is embedded as a caller ID in the call set-up message.

The ID typically comprises of a caller identification number corresponding to at least one push initiator 19. In most cases the identification number is a telephone number which corresponds to a caller ID. However, it should be understood that the number is a real telephone number, i.e., this is the number associated with the phone line, and attached as the caller ID by the local switch. However, in some cases the number can be a pseudo telephone number, i.e., the number is generated by a switch on the network as a result of a request which was directed to it from a specific PI 19, for example, using HTTP Post. In this case, no phone line were used, so the switch needs to fabricate one, which may be a real or bogus telephone number, and with this invention it does not matter, as long as the phone, when searching the PIDB 26 discovers that identification number.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method for initiating a push session, comprising:
(a) sending a message from a push initiator to a device, wherein said message has at least one embedded ID corresponding to said push initiator;
(b) matching said embedded ID with a list of ID's in said device;
(c) rejecting said message if the embedded ID matches with at least one ID in said device, and triggering said device to initiate a push session with said push initiator.

2. The method of claim 1 wherein said ID is selected from a group consisting of at least one numeric number, alphanumeric number, tone and symbol.

3. The method of claim 1 wherein said push initiator is selected from a group consisting of computer, phone and PDA.

4. The method of claim 1 wherein said device is selected from a group consisting of computer, phone and PDA.

5. The method of claim 1 wherein said message from said push initiator to said device is sent via at least one mobile network.

6. The method of claim 1 wherein means for communication between said push initiator and said device is via wireless.

7. The method of claim 1 wherein means for communication between said push initiator and said device is selected from a group consisting of wire line, telephone line, cable line, electrical line and fiber optic line.

8. The method of claim 1 wherein said list of ID's is stored in a push initiator data base.

9. The method of claim 1 wherein said list of ID's is stored in a push initiator data base contained in said device.

10. The method of claim 1 wherein said device is set-up from a remote location.

11. A method of setting-up a device, comprising:
(a) accessing a memory location on said device; and
(b) storing at least one ID corresponding to at least one push initiator.

12. The method of claim 11 wherein said ID is selected from a group consisting of at least one numeric number, alphanumeric number, tone and symbol.

13. The method of claim 11 wherein said device is selected from a group consisting of computer, phone and PDA.

14. The method of claim 11 wherein said ID is stored in a push initiator data base contained in said device.

15. The method of claim 11 wherein said ID comprises the name of at least one push initiator.

16. The method of claim 11 wherein said ID comprises a caller identification number corresponding to at least one push initiator.

17. The method of claim 11 wherein said ID comprises a caller identification number corresponding to at least one push initiator, and wherein said identification number is associated with a phone line which is attached as a caller identification number by a local switch.

18. The method of claim 11 wherein said ID comprises a caller identification number corresponding to at least one push initiator, and wherein said identification number is a pseudo telephone number and wherein said number is generated by a switch on a network as a result of a request which was directed to it from a specific Push Initiator.

19. A method for initiating a push session, comprising, sending a message from a push initiator to a telephony device wherein said message is sent via a telephony network as a call initiation request.

20. The method of claim 19 wherein said message has at least one embedded ID corresponding to said push initiator.

21. An apparatus comprising a push initiator connected to a communication device.

22. The apparatus of claim 21 wherein communication between said push initiator and said communication device is via at least one mobile network.

23. The apparatus of claim 21 wherein means for communication between said push initiator and said communication device is via wireless.

24. The apparatus of claim 21 wherein means for communication between said push initiator and said communication device is selected from a group consisting of wire line, telephone line, cable line, electrical line and fiber optic line.

25. The apparatus of claim 21 wherein said push initiator is selected from a group consisting of computer, phone and PDA.

26. The apparatus of claim 21 wherein said communication device is selected from a group consisting of computer, telephone and PDA.

27. The apparatus of claim 21 wherein said communication device has a set of IDs that correspond to at least one push initiator.

28. The apparatus of claim 21 wherein said communication device has a set of IDs that correspond to at least one push initiator, and wherein said IDs is selected from a group consisting of at least one numeric number, alphanumeric number, tone and symbol.
